(19) United States
(12) Patent Application Publication
(10) Pub. No.: US 2026/0210786 A1
(43) Pub. Date: Jul. 23, 2026

(54) PRESSURE TRANSDUCER

(71) Applicant: Endress+Hauser SE+Co. KG, Maulburg (DE)

(72) Inventors: Alexander Vogel, Kirchzarten (DE); Timo Kober, Potsdam (DE); Alexander Niedermayer, Wehr (DE)

(21) Appl. No.: 19/139,958

(22) PCT Filed: Dec. 7, 2023
(86) PCT No.: PCT/EP2023/084704

§ 371 Date: Jun. 17, 2025

(30) Foreign Application Priority Data
Dec. 19, 2022 (DE) 10 2022 133 825.8

(51) Int. Cl. G01L 19/06; G01L 19/00

(52) U.S. Cl. CPC G01L 19/0672; G01L 19/0046

(57) ABSTRACT

A pressure transducer includes a pressure sensor having a measuring diaphragm, a hydraulic diaphragm seal having a diaphragm seal body, and a separating diaphragm connected to the diaphragm seal body to form a diaphragm seal chamber. The separating diaphragm is hydraulically coupled to the measuring diaphragm via the diaphragm seal chamber so that a pressure which is applied to the separating diaphragm is passed on to the measuring diaphragm. An evaluation circuit is designed to output a pressure measurement signal corresponding to a deflection of the measuring diaphragm. A detection unit generates a frequency spectrum from the pressure measurement signal and compares a partial range of the generated frequency spectrum with a partial range of a frequency spectrum which is characteristic of the pressure transducer, and determines an indication if there is a significant deviation and also interprets this indication as a leakage of the separating diaphragm.

The invention relates to a pressure transducer.

In pressure measurement technology, absolute, differential and relative pressure transducers are known. Absolute pressure transducers determine the prevailing pressure absolutely, i.e., in relation to vacuum, while differential pressure transducers determine the difference between two different pressures. For relative pressure transducers, the pressure to be measured is determined relative to a reference pressure, with the atmospheric pressure prevailing in the environment of the relative pressure transducer serving as the reference pressure. Companies of the Endress+Hauser Group manufacture and sell a variety of such absolute pressure, differential pressure and relative pressure transducers.

Pressure transducers are used to measure pressure and/or to control a process taking place in the system using open-loop or closed-loop control and/or automate it. Pressure measuring devices are used in automation technology in a wide variety of industries, e.g., in the chemical and food industries, to name just a few important fields of application. Differential pressure measuring devices are used in particular for continuously measuring pressure differences in measurement media, for example in liquids, vapors, gases and dusts. From the differential pressure, the fill-level of contents in a tank or the flow of a measurement medium through a pipe conduit, for example, can be determined.

Pressure and differential pressure transducers have a pressure-sensitive element, a so-called pressure sensor, which is subjected to a first pressure and a second pressure on two opposite surfaces. The medium is generally not in direct contact with the pressure sensor, but is recorded by one pressure-sensitive diaphragm directed toward the process in the case of the pressure transducer and by two pressure-sensitive diaphragms directed toward the process in the case of the differential pressure transducer. Each diaphragm has an associated diaphragm bed, which serves to emboss the diaphragm and to limit the movement of the diaphragm in the event of an overload. Often, a diaphragm seal fluid is also used, which transmits the pressure of the medium acting on the diaphragm to one of the two surfaces of the pressure sensor via a pressure transmission path.

In order to achieve diaphragms, also known as separating diaphragms, that have a sufficiently large hydraulic capacity, these are usually made of steel sheets or foils with thicknesses of a few 10 μm to a few 100 μm. However, this low material thickness entails a certain risk of leakage, especially when the separating diaphragms are exposed to abrasive or corrosive media.

This problem is generally known and there are numerous approaches to diagnosing a leak. For example, DE 102 00 779 B4 , EP 1 275 951 B1 and EP 0 838 672 A1 describe apparatuses in which properties of the transmission fluid are to be monitored. After a leak occurs, an exchange should take place between the transmission fluid and the measuring medium, which should bring about a change in the electrical conductivity or permittivity. However, it has been found that the media exchange that occurs in the event of a leak occurs substantially as a result of diffusion and is therefore too slow to result in a detectable change in a property of the transmission fluid in the diaphragm seal chamber within a useful amount of time.

Other approaches follow a concept that uses a double diaphragm system, with a vacuum being created in the space between the two diaphragms. If the pressure in the gap then rises above a threshold value, a rupture of at least the first diaphragm can be detected. The disadvantages of this approach are that the overall diaphragm system becomes stiffer, manufacturing costs increase due to increased complexity and an additional sensor is required to monitor the pressure in the gap.

The object of the invention is to remedy this.

The object is achieved according to the invention by the pressure transducer according to claim 1.

The pressure transducer according to the invention comprises at least:
a pressure sensor comprising a measuring diaphragm;
a hydraulic diaphragm seal comprising a diaphragm seal body and a separating diaphragm, which is connected to the diaphragm seal body to form a diaphragm seal chamber between the separating diaphragm and said diaphragm seal body, wherein the separating diaphragm is hydraulically coupled to the measuring diaphragm via the diaphragm seal chamber so that a pressure that is to be determined and is applied to the separating diaphragm is passed on to the measuring diaphragm,
wherein the pressure transducer further comprises an operating and/or evaluation circuit which is configured to output a pressure measurement signal corresponding to a deflection of the measuring diaphragm,
wherein the pressure transducer further comprises a detection unit which is configured to generate a frequency spectrum, in particular an acoustic frequency spectrum of the pressure transducer, from the pressure measurement signal and to compare at least a partial range of the frequency spectrum generated, in particular the acoustic frequency spectrum generated, with at least a partial range of a frequency spectrum that is characteristic of the pressure transducer, in particular a characteristic acoustic frequency spectrum, and to determine an indication if at least the partial range of the frequency spectrum generated, in particular the acoustic frequency spectrum generated, significantly deviates from the at least one partial range of the frequency spectrum characteristic of the pressure transducer, in particular the acoustic frequency spectrum characteristic of the pressure transducer, and to further interpret this indication as a leak in the separating diaphragm.

The invention proposes recording and evaluating a frequency spectrum of a pressure transducer. The frequency spectrum may preferably be an acoustic frequency spectrum which lies in a range that is below 200 kHz, in particular below 25 kHz, in particular in the range of 0 -20 kHz, and very particularly in the range of 5 Hz- 1 kHz. The spectrum characterizes the pressure transducer and represents a sort of fingerprint of the pressure transducer. A change to the pressure transducer affects the frequency spectrum, especially the acoustic frequency spectrum. According to the invention, this is used to detect a leak or a rupture in the separating diaphragm.

An advantageous embodiment of the pressure transducer according to the invention can provide that the detection unit is further configured to remove a component of the pressure measurement signal that represents a pressure measurement value from the pressure measurement signal. In particular, the embodiment can provide that the detection unit is further configured to remove the signal component representing the pressure measurement value from the pressure measurement signal by means of a high-pass filter. In addition, the embodiment may provide that the high-pass filter is designed to have a cutoff frequency of a few Hz, preferably a cutoff frequency in the range of 3-7 Hz, particularly preferably a cutoff frequency of approximately 5 Hz.

Yet another advantageous embodiment of the pressure transducer according to the invention can provide that the detection unit is further configured to generate the frequency spectrum, in particular the acoustic frequency spectrum of the pressure transducer, from the pressure measurement signal by means of a Fourier analysis, in particular a fast Fourier analysis. In particular, the embodiment can provide that the detection unit is further configured to generate the frequency spectrum, in particular the acoustic frequency spectrum of the pressure transducer, by adding up all of frequencies of the spectrum generated by means of the Fourier analysis, in particular gradually.

A further advantageous embodiment of the pressure transducer according to the invention can provide that the detection unit is further configured to normalize the frequency spectrum, in particular the acoustic frequency spectrum of the pressure transducer, by means of a normalizer so that at least a partial range of the normalized frequency spectrum, in particular the normalized acoustic frequency spectrum, is compared with at least a partial range of a normalized frequency spectrum that is characteristic of the pressure transducer, in particular a normalized characteristic acoustic frequency spectrum, and an indication is determined if at least the partial range of the normalized frequency spectrum generated, in particular the normalized acoustic frequency spectrum, significantly deviates from the at least one partial range of the characteristic normalized frequency spectrum, in particular the normalized acoustic frequency spectrum characteristic of the pressure transducer.

A further advantageous embodiment of the pressure transducer according to the invention can provide that the detection unit is further configured to amplify the frequency spectrum, in particular the acoustic frequency spectrum of the pressure transducer from the pressure measurement signal, within a frequency range by means of an equalizer.

A further advantageous embodiment of the pressure transducer according to the invention can provide that the detection unit is further configured to determine the indication if the frequency spectrum, in particular the acoustic frequency spectrum of the pressure transducer, in particular the total frequency spectrum, exhibits low-pass behavior as a significant deviation from the characteristic frequency spectrum, in particular the acoustic frequency spectrum characteristic of the pressure transducer.

A further advantageous embodiment of the pressure transducer according to the invention can provide that the detection unit is configured to generate the frequency spectrum, in particular the acoustic frequency spectrum of the pressure transducer, from the pressure measurement signal at regular intervals.

Yet another advantageous embodiment of the pressure transducer according to the invention can provide that process noise, preferably process noise at a measuring point of the pressure transducer or an artificially generated and/or known noise or sounds is/are used to generate the characteristic frequency spectrum, in particular the characteristic acoustic frequency spectrum.

Yet another advantageous embodiment of the pressure transducer according to the invention can provide that the measuring diaphragm has a first hydraulic capacity dV1/dp and the separating diaphragm has a second hydraulic capacity dV2/dp, wherein the second hydraulic capacity is preferably greater than the first hydraulic capacity, and wherein the separating diaphragm has an equilibrium position in which the pressure in the diaphragm seal chamber is equal to the pressure on an outer side of the separating diaphragm facing away from the diaphragm seal chamber, wherein an equilibrium volume of the diaphragm seal chamber corresponds to the equilibrium position, and wherein, in an operating state of the pressure transducer, the diaphragm seal chamber has an operating volume which differs from the equilibrium volume so that a pressure difference between a pressure in the diaphragm seal chamber and the pressure on the outer side of the separating diaphragm is not less than a threshold value.

The invention is explained in more detail on the basis of the following drawings. In the figures:

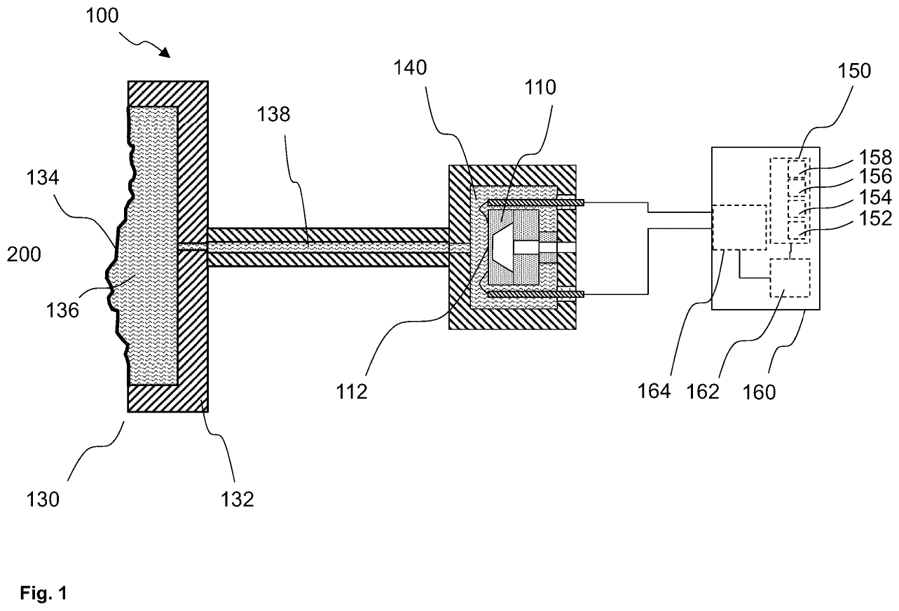

FIG. 1: shows an overall view of an embodiment of a pressure transducer according to the invention,

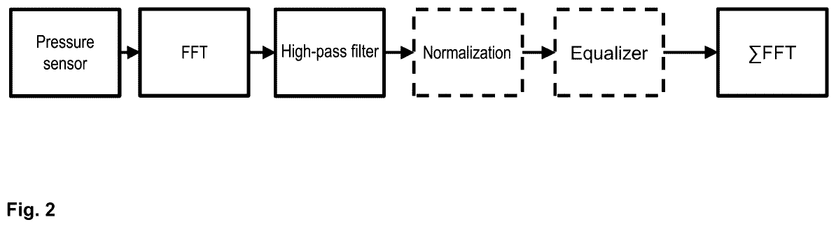

FIG. 2: shows a signal chain executed or implemented in the detection unit, and

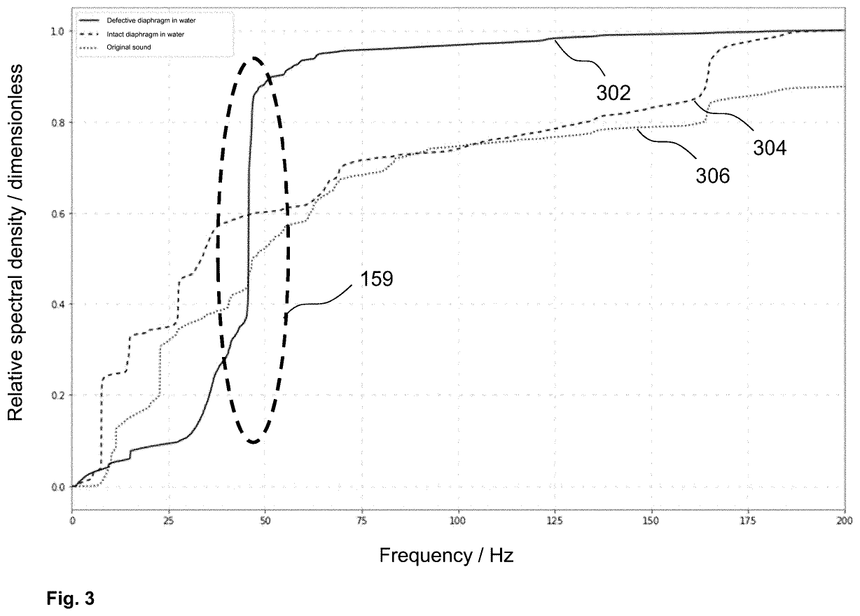

FIG. 3: shows an acoustic spectrum of the pressure transducer, which has been generated by adding up all the frequencies of the spectrum generated by means of a Fourier analysis.

The pressure transducer 100 shown in FIG. 1 comprises a pressure sensor, here a piezoresistive pressure sensor 110, comprising a measuring diaphragm 112, wherein the pressure sensor 110 comprises resistance elements in a bridge circuit in order to convert the pressure-dependent deformation or deflection of the measuring diaphragm into an electrical signal. Instead of the piezoresistive pressure sensor, a capacitive pressure sensor can also be provided, in which case the measuring diaphragm has an electrode, the capacitance of which with respect to an electrode on a rigid counter body is a measure of the pressure-dependent deformation or deflection of the measuring diaphragm. Those skilled in the field of pressure measurement technology are familiar with details regarding electrical converters and these need not be explained in detail here.

The pressure transducer 100 further comprises a hydraulic diaphragm seal 130 comprising a diaphragm seal body 132 and a separating diaphragm 134. The separating diaphragm 134 is joined, i.e., welded or soldered, to the diaphragm seal body 132 along a circumferential edge so as to form the diaphragm seal chamber 136 between the two joining partners. A channel 138 extends from the diaphragm seal chamber 136 and into a pressure sensor chamber 140 in which the pressure sensor 110 is arranged. The pressure sensor chamber 140 is coupled to the diaphragm seal chamber via a transmission fluid so that the measuring diaphragm 112 is hydraulically coupled to the separating diaphragm 134. This means that the pressure introduced into the diaphragm seal chamber 136 via the separating diaphragm 134 is substantially applied at the measuring diaphragm 112.

The division of the hydraulic system described into a pressure sensor chamber 140 and a diaphragm seal chamber 136 as well as a channel connecting the chambers is advantageous but not absolutely necessary. In order to implement the invention, the pressure sensor can also be arranged in the diaphragm seal chamber.

The transmission fluid generally has a greater thermal volume expansion than the chambers and channels that surround it. This results in a volumetric stroke which is to be absorbed not by deflection of the sensor diaphragm 112 but by deflection of the separating diaphragm 134. That is, the measuring diaphragm 112 has a first hydraulic capacity dV1/dp, and the separating diaphragm 134 has a second hydraulic capacity dV2/dp, wherein the second hydraulic capacity is substantially greater than the first hydraulic capacity.

The separating diaphragm 134 is an elastic body for which an equilibrium position is specified, in which position the pressure in the diaphragm seal chamber 136 is equal to the pressure on an outer side of the separating diaphragm 134 facing away from the diaphragm seal chamber 136. The equilibrium position of the separating diaphragm 134 corresponds to an equilibrium volume of the diaphragm seal chamber 136.

However, it is provided that, in an operational state—in short an operating state—of the pressure transducer 100, the diaphragm seal chamber 136 has an operating volume VB which deviates from the equilibrium volume VO to such an extent that a pressure difference ΔpB between a pressure in the diaphragm seal chamber 136 and the pressure on the outer side of the separating diaphragm 134 is not less than a threshold value ΔpS of, for example, a few 10 mbar, in particular of at least 40 mbar, very particularly of at least 60 mbar, very very particularly of approximately 70 mbar. This causes, in the event of a leak, transmission fluid to be forced out of the diaphragm seal chamber 136 until the pressure between the diaphragm seal chamber 136 and the volume on the outer side of the separating diaphragm 134 has been equalized. As a result, the current position of the separating diaphragm 134 in particular also changes.

In order to generate a pressure measurement signal comprising the pressure measurement values, the pressure transducer 100 comprises an operating and/or evaluation circuit 160 which is configured to output a pressure measurement signal corresponding to a deflection of the measuring diaphragm 112. For this purpose, the operating and/or evaluation circuit can, for example, comprise a microprocessor 162 for processing signals from the pressure sensor 110 that are digitized by means of an ADC 164.

According to the invention, the pressure transducer 100 further comprises a detection unit 150 which generates a frequency spectrum, in particular an acoustic frequency spectrum of the pressure transducer 100, from the pressure measurement signal and compares the acoustic frequency spectrum generated with an acoustic frequency spectrum characteristic of the pressure transducer 100, in particular a characteristic acoustic frequency spectrum, and determines an indication of a leak in the separating diaphragm 134 if the frequency spectrum generated, in particular the acoustic frequency spectrum, significantly deviates from the characteristic frequency spectrum, in particular the acoustic frequency spectrum characteristic of the pressure transducer 100. The detection unit 150 can, as shown in FIG. 1, be designed as part of the operating and evaluation circuit 160, or alternatively as a separate unit. For example, the detection unit can also be designed so as to be separated from the pressure transducer, e.g., in a cloud or the like.

Further details of the detection unit 150 and the associated signal processing are shown in FIGS. 2 and 3 and will now be explained.

FIG. 2 shows an example of a signal chain, particularly one executed in the detection unit 150. According to the embodiment shown in FIG. 2, in a first step, the pressure measurement signal coming from the pressure sensor, which can preferably represent a digital signal, undergoes a Fourier analysis 158, in particular a fast Fourier analysis (FFT for short). The signal component representing the actual pressure measurement value is then removed. This can be done, for example, by means of a high-pass filter.

The high-pass filter 152 can be realized with a cutoff frequency of a few Hz. A cutoff frequency in the range of 3-7 Hz, e.g., approx. 5 Hz, has proven to be particularly advantageous. As an alternative to high-pass filtering, the signal component representing the actual pressure measurement value can also be removed by a moving average.

This signal is then normalized in a further optional step by a normalization unit 154 of the detection unit 150, i.e., a preferably constant amplification factor is applied to the signal over the entire frequency range in order to bring the amplitude to a target level, e.g., “1.”

In a subsequent optional step, the normalized signal that has been passed through a high-pass filter is amplified in a specific frequency range using an equalizer 156. The frequency range in which amplification by means of the equalizer occurs depends on the measuring system setup, such as the measuring diaphragm size, etc. The amplification means that the entire frequency range does not have to be considered, but only the range in which, in the event of diaphragm rupture, a change in the transmission behavior is shown for the corresponding measuring system setup. Even if, according to the embodiment, normalization takes place before amplification by means of the equalizer, this is not absolutely necessary and can also take place in the reverse order.

In a subsequent step, all the frequencies of the frequency spectrum generated can, in turn, be added up, in particular gradually. FIG. 3 shows such a total frequency spectrum for two different pressure transducers. A first total frequency spectrum 302 originates from a pressure transducer comprising a ruptured separating diaphragm 134 and a second total frequency spectrum 304 originates from a pressure transducer 100 comprising an intact or non-ruptured separating diaphragm 134. This second total frequency spectrum serves as the characteristic frequency spectrum, in particular the characteristic acoustic frequency spectrum.

To generate the characteristic frequency spectrum, in particular the characteristic acoustic frequency spectrum 304, process noise that is constantly present anyway, in particular at the measuring point of the pressure transducer, or an artificially generated and/or known noise or sounds can be used. For this purpose, a third frequency spectrum 306 is shown in FIG. 3, which serves as an artificially generated noise. The cumulative curve 304 can be regarded as a sort of fingerprint of the noise 306 recorded by the pressure sensor.

It is clearly visible in FIG. 3 that low-pass behavior occurs in the first frequency spectrum, which in this example occurs at just below 50 Hz, approx. 48 Hz. The low-pass behavior does not have to be approximately 50 Hz, as shown in FIG. 3, but depends on the measuring system setup, such as the diameter of the line into which the pressure transducer is inserted or the size of the measuring diaphragm of the pressure transducer. This low-pass behavior is used by the detection unit 150 to determine an indication that the frequency spectrum generated, in particular the acoustic frequency spectrum, significantly deviates from the characteristic frequency spectrum, in particular the acoustic frequency spectrum characteristic of the pressure transducer 100, and to interpret this indication as a leak or rupture in the separating diaphragm 112.

### List of Reference Signs

100 Pressure transducer
110 Pressure sensor
112 Measuring diaphragm
130 Diaphragm seal
132 Diaphragm seal body
134 Separating diaphragm
136 Diaphragm seal chamber
138 Channel
140 Pressure sensor chamber
150 Detection unit
152 High-pass filter
154 Normalization unit
156 Equalizer
158 Fourier analysis
159 Low-pass behavior
160 Operating and evaluation circuit
162 Microprocessor
164 ADC
200 Process medium
300 Acoustic spectrum
302 First total acoustic spectrum
304 Second total acoustic spectrum
306 Third or characteristic total spectrum

1-12. (canceled)

13. A pressure transducer, comprising:
a pressure sensor having a measuring diaphragm;
a hydraulic diaphragm seal comprising a diaphragm seal body and a separating diaphragm which is connected to the diaphragm seal body to form a diaphragm seal chamber between the separating diaphragm and said diaphragm seal body, wherein the separating diaphragm is hydraulically coupled to the measuring diaphragm via the diaphragm seal chamber so that a pressure that is to be determined is applied to the separating diaphragm is passed on to the measuring diaphragm;
wherein the pressure transducer further comprises an operating and/or evaluation circuit which is configured to output a pressure measurement signal corresponding to a deflection of the measuring diaphragm,
wherein the pressure transducer further comprises a detection unit which is configured to generate a frequency spectrum from the pressure measurement signal and to compare at least a sub-range of the frequency spectrum generated with at least a partial range of a frequency spectrum that is characteristic of the pressure transducer and to determine an indication if at least the partial range of the frequency spectrum generated significantly deviates from the at least one partial range of the frequency spectrum that is characteristic of the pressure transducer and to further interpret this indication as a leak in the separating diaphragm.

14. The pressure transducer according to claim 13, wherein the detection unit is further configured to remove a component of the pressure measurement signal that represents a pressure measurement value from the pressure measurement signal.

15. The pressure transducer according to claim 14, wherein the detection unit is further configured to remove the component from the pressure measurement signal that represents the pressure measurement value using a high-pass filter.

16. The pressure transducer according to claim 15, wherein the high-pass filter is designed such that it has a cutoff frequency of a few Hz.

17. The pressure transducer according to claim 13, wherein the detection unit is further configured to generate the frequency spectrum from the pressure measurement signal using a Fourier analysis.

18. The pressure transducer according to claim 17, wherein the detection unit is further configured to generate the frequency spectrum by adding up all the frequencies of the spectrum generated using a Fourier analysis.

19. The pressure transducer according to claim 13, wherein the detection unit is further configured to normalize the frequency spectrum using a normalizer such that at least a partial range of the normalized frequency spectrum is compared with at least a partial range of a normalized frequency spectrum that is characteristic of the pressure transducer and an indication is determined if at least the partial range of the normalized frequency spectrum generated significantly deviates from the at least one partial range of the characteristic normalized frequency spectrum.

20. The pressure transducer according to claim 13, wherein the detection unit is further configured to amplify the frequency spectrum within a frequency range using an equalizer.

21. The pressure transducer according to claim 13, wherein the detection unit is further configured to determine the indication if the frequency spectrum exhibits low-pass behavior as a significant deviation from the characteristic frequency spectrum.

22. The pressure transducer according to claim 13, wherein the detection unit is configured to generate the frequency spectrum from the pressure measurement signal at regular intervals.

23. The pressure transducer according to claim 13, wherein process noise is/are used to generate the characteristic frequency spectrum.

24. The pressure transducer according to claim 13, wherein the measuring diaphragm has a first hydraulic capacity dV1/dp and the separating diaphragm has a second hydraulic capacity dV2/dp, wherein the second hydraulic capacity is preferably greater than the first hydraulic capacity, and wherein the separating diaphragm has an equilibrium position in which the pressure in the diaphragm seal chamber is equal to the pressure on an outer side of the separating diaphragm facing away from the diaphragm seal chamber, wherein an equilibrium volume of the diaphragm seal chamber corresponds to the equilibrium position, and wherein, in an operating state of the pressure transducer, the diaphragm seal chamber has an operating volume which differs from the equilibrium volume so that a pressure difference between a pressure in the diaphragm seal chamber and the pressure on the outer side of the separating diaphragm is not less than a threshold value.
